(19) United States
(12) Patent Application Publication
(10) Pub. No.: US 2023/0127250 A1
(43) Pub. Date: Apr. 27, 2023

(54) Workpiece Fixing Device, Grinding Machine, and Method for Fixing a Workpiece

(71) Applicant: Karl Heesemann Maschinenfabrik GmbH & Co. KG, Bad Oeynhausen (DE)

(72) Inventor: Christoph Giese, Bad Oeynhausen (DE)

(21) Appl. No.: 18/047,398

(22) Filed: Oct. 18, 2022

(30) Foreign Application Priority Data
Oct. 22, 2021 (EP) 21204296.4

(51) Int. Cl. B24B 41/06; B24B 51/00; B24B 7/06; B24B 49/04; B24B 41/00

(52) U.S. Cl. CPC B24B 41/06; B24B 51/00; B24B 7/06; B24B 49/04; B24B 41/005

(57) ABSTRACT

A workpiece fixing device for fixing a workpiece by vacuum for machining thereof includes a support device on which the workpiece can be laid for fixing, and at least one vacuum chamber which is formed starting from the support device. The workpiece fixing device has a first fixing region and a second fixing region different from the first fixing region. The support device has a first support channel profile in the first fixing region and a second support channel profile different from the first support channel profile in the second fixing region.

### FIELD OF THE INVENTION

The invention concerns a workpiece fixing device for fixing a workpiece by vacuum for machining thereof, having a support device on which the workpiece may be laid for fixing, and at least one vacuum chamber which is formed starting from the support device.

The invention furthermore concerns a grinding machine and a method for fixing a workpiece by vacuum for machining thereof, with a workpiece fixing device.

### BACKGROUND

It is known to fix workpieces for machining, for example by a grinding machine, to a support device by means of a workpiece fixing device. For this, the workpiece fixing device may have a suction device. The support device may comprise a stationary table unit and a conveyor belt moving relative to the table unit for conveying the workpiece to be fixed in a main machining direction.

For fixing the workpiece to the support device, the latter may have suction openings through which the suction device aspirates air. If a workpiece is now arranged on the support device, it covers individual suction openings. Depending on the size of the workpiece and the distribution of the suction openings, the workpiece to be machined covers a greater or smaller number of suction openings of the support device. The larger the workpiece or the closer together the suction openings are arranged, the greater the resulting holding force generated by the suction device.

In workpiece machining, for example with a continuous grinding machine with wide belts or other machining units, the holding force for the workpiece is determined by the number of suction openings in engagement (in the form of passage bores or suction channels in the support device), the vacuum pressure and other parameters. DE 10 2016 117 992 A1, DE 10 2008 059 177 B4, DE 20 2010 013 582 U1, DE 195 18 373 A1, DE 29 39 571 A1, DE 43 07 432 C2, DE 20 2008 004 820 U1 and DE 199 63 461 B4 describe solutions which allow fixing of workpieces to a support device with a suction device.

However, with these solutions, it may occur that for smaller workpieces, not enough suction openings are in engagement with the workpiece to be machined to securely fasten the workpiece for machining. Furthermore, with smaller workpieces, the support device is insufficiently covered, so high vacuum losses occur.

It is known to eliminate this problem with workpiece holders which can receive smaller workpieces. However, this has the disadvantage that only small or only large workpieces can be machined; mixed operation is not possible. The use of such workpiece holders therefore leads to comparatively high adaptation costs and long adaptation times.

### SUMMARY

The invention is therefore based on the object of providing a workpiece fixing device, a grinding machine and a method for fixing a workpiece with a workpiece fixing device, which do not have the described disadvantages.

An object is achieved with a workpiece fixing device for fixing a workpiece by vacuum for machining thereof. The workpiece fixing device is in particular a workpiece fixing device of a material removal machine. The material removal machine is preferably a grinding machine, particularly preferably a wide belt grinding machine. The workpiece fixing device is in particular suitable for fixing workpieces for machining by grinding.

The workpiece fixing device has a support device on which the workpiece to be machined may be laid for fixing. The support device may for example be formed by or comprise one or more workpiece support plates or one or more workpiece support surfaces. Furthermore, the support device may in particular be formed by or comprise one or more workpiece conveyor belts. For machining of a workpiece, the workpiece is arranged on the support device and fixed to the support device. To secure the workpiece to the support device, the support device preferably has a suction surface and an extraction surface. A suction surface here is a surface on which the workpiece to be fixed is laid and held by suction. Usually, atmospheric pressure prevails on the side of the suction surface. In contrast, in operation, a pressure lower than atmospheric pressure prevails at the extraction surface. The extraction surface is in particular a surface facing away from the suction surface. The support device preferably extends between the suction surface for workpieces and the extraction surface, orthogonally to a main machining direction.

Preferably, the suction surface and the extraction surface of the support device extend in a plane. The extraction surface and the suction surface are preferably arranged spaced apart from one another. In particular, the extraction surface and the suction surface extend parallel to one another.

Furthermore, the workpiece fixing device has at least one vacuum chamber which is formed starting from the support device. The extraction surface may be a surface facing the at least one vacuum chamber. The air aspirated from the environment on the suction surface side is extracted on the extraction surface side in the direction of the at least one vacuum chamber. It is furthermore preferred that the at least one vacuum chamber is formed starting from the extraction surface of the support device. In particular, the vacuum chamber is arranged on the support device. Preferably, the vacuum chamber is arranged on the extraction surface of the support device. Preferably, the extraction surface of the support device forms an inner wall of the vacuum chamber.

The at least one vacuum chamber in particular has a lower pressure than an environment of the workpiece fixing device. The ambient pressure may vary depending on weather. A reduced pressure inside the vacuum chamber is preferably generated with a suction device.

The workpiece fixing device has a first fixing region and a second fixing region different from the first fixing region. In the first fixing region, the support device has a first support channel profile. In the second fixing region, the support device has a second support channel profile different from the first support channel profile.

The support channel profile in the sense of the invention is the total of features which are formed by a plurality of channels in the respective fixing region and their arrangement relative to one another. Examples of such features are the contour of the cross-sectional area of a channel (e.g. circular, elongate, in the form of a triangle, square or cross), in particular the contour of the cross-section in the region of a workpiece support surface of the support device, one or more dimensions of this cross-section, the mutual spacing of the channels in one direction or in another direction, the number of channels per surface, the cross-sectional area assumed by channels relative to the total area within which the channels are arranged. At least one of these features in the first support channel profile is different from the second support channel profile. Preferably, the channels of a support channel profile are identical.

The first and/or second support channel profile is designed to connect the environment of the workpiece fixing device to the vacuum chamber. The first and/or second support channel profile is preferably an arrangement of passage openings which fluidically connect the suction side to the extraction side. In particular, the first and/or second support channel profile has an arrangement of several channels which extend from the suction surface to the extraction surface. Preferably, the channels are configured to fluidically connect the environment of the workpiece fixing device to the vacuum chamber.

Preferably, the first and/or second support channel profile is configured as a hole profile. A hole profile may in particular have channels with circular cross-section and/or a polygonal cross-section, preferably a square or rectangular cross-section. Furthermore, it may be preferred that the first and/or second support channel profile is formed as a slot profile. In particular, the hole profile of the first support channel profile may differ from the hole profile of the second support profile. In particular, it is preferred that the cross-section of the channels of the hole profile of the first support channel profile differs from the cross-section of the channels of the hole profile of the second support channel profile. Particularly preferably, the first support channel profile comprises grooves, in particular groove-like channels or channels formed as slots, and the second support channel profile comprises channels formed as bores. With this embodiment, preferably a substantially larger vacuum clamping surface is created.

Preferably, the channels of the first and/or second support channel profile are equidistant from one another. It may be preferred that at least partially, the channels are spaced apart from one another by varying distances.

Because of the division of the workpiece fixing device into the first fixing region and the second fixing region, different from the first fixing region, different support channel profiles may be provided with varying numbers and densities of channels. In this way, the number of channels in engagement with a workpiece to be fixed, or which are covered by the workpiece lying on the support device, may be controlled.

Furthermore, the division into different fixing regions allows different vacuum levels to be provided in vacuum chambers for each fixing region, if the workpiece fixing device has several vacuum chambers. In particular, the vacuum chamber for the one fixing region may be fully deactivated if no workpiece is to be fixed in this fixing region. Vacuum chambers may be switched on or off accordingly, or chamber volumes of the individual vacuum chambers therein may be varied depending on workpiece size.

In particular, in this way, vacuum losses in the vacuum chambers can be minimized.

According to a preferred embodiment, it is provided that the workpiece fixing device has a slide device arranged in the first fixing region, wherein the slide device and the support device are arranged so as to be movable relative to one another. Preferably, the slide device and the support device are arranged so as to be movable translationally and/or rotationally relative to one another.

In particular, the slide device has a slide channel profile. The slide channel profile is configured to fluidically connect and/or close the first support channel profile of the workpiece fixing device to and/or against the vacuum chamber. In particular, the slide device has channels which extend from the extraction surface to the vacuum chamber. Preferably, the channels of the slide channel profile are configured to fluidically connect the first support channel profile of the workpiece fixing device to the vacuum chamber.

In particular, the slide device is configured to vary, at least in portions, the first support channel profile between the suction surface and the extraction surface. Preferably, the slide device is configured to vary, at least in portions, individual or multiple channels of the first support channel profile between the suction surface and the extraction surface. In particular, the slide device is preferably configured to vary, at least in portions, cross-sections of individual or multiple channels of the first support channel profile between the suction surface and the extraction surface.

Preferably, the slide channel profile is configured as a hole profile. A hole profile may in particular have channels with circular cross-section and/or a polygonal cross-section, preferably a square or rectangular cross-section. Furthermore, it may be preferred that the slide channel profile is formed as a hole profile. Preferably, the channels of the slide channel profile are equidistant from one another. It may be preferred that, at least partially, channels have a varying spacing from one another.

Preferably, the slide device is movable relative to the support device orthogonally to the main machining direction. In particular, the slide device is movable in a plane parallel to the support device, in particular the suction surface and/or an extraction surface. Preferably, the slide device is arranged between the suction surface and the extraction surface.

In a preferred embodiment of the workpiece fixing device, the slide device extends over the first fixing region. Particularly preferably, the slide device extends over one or more part regions of the first fixing region. The slide device is in particular configured to vary the first support channel profile, at least in portions. In particular, it may be preferred that the slide device is configured to fluidically close individual channels of the first support channel profile.

By means of the slide device, a suitable suction profile may be established depending on workpiece size. In particular, the slide device allows the vacuum resulting in the at least one vacuum chamber to be varied. Furthermore, preferably, the flow speed of the air aspirated from the environment through individual channels of the first support channel profile can be controlled. This allows firstly optimal fixing of workpieces for machining, and secondly minimizing of power losses. Furthermore, the workpiece fixing device may be adapted to the size of the workpiece to be machined without long adaptation times and high adaptation costs.

According to a preferred refinement of the workpiece fixing device, the slide device and/or the support device are configured so they can be moved to and fro, relative to one another, between a first slide position and a second slide position different from the first. In particular, the slide device and/or the support device are configured so they can be moved to and fro, translationally and/or rotationally, relative to one another, between the first slide position and the second slide position. Here, the slide device and the support device, in the first slide position of the slide device, form a first suction hole profile, and in the second slide position of the slide device, form a second suction hole profile different from the first suction hole profile. Preferably, the first suction hole profile is the first support channel profile.

A suction hole profile in the sense of the invention in particular means the total of features which are formed by a plurality of channels by the interaction of the position of the slide device relative to the support device and their arrangement relative to one another.

Examples of such features are the contour of the cross-sectional area of a channel (e.g. circular, elongate, in the form of a triangle, square or cross), in particular the contour of the cross-section in the region of a workpiece support surface of the support device and/or the slide device, one or more dimensions of this cross-section, the mutual spacing of the channels in one direction or in another direction, the number of channels per surface, the cross-sectional area assumed by channels relative to the total area within which the channels are arranged. At least one of these features in the first suction hole profile is different from the second suction hole profile. Preferably, the channels of a suction hole profile are identical.

The preferred embodiment has the advantage that the suction hole profile can be adapted depending on the size of the workpiece to be machined. In particular, with this preferred embodiment, workpieces of different size may be fixed simultaneously to the workpiece fixing device. This firstly reduces the adaptation costs and secondly accelerates the machining of workpieces by the parallel or simultaneous machining of the workpieces.

Furthermore, in a preferred refinement, it is provided that the slide device has one or more sliding units which are configured to be moved to and fro, relative to the support device, dependently or independently of one another, between the first slide position and the second slide position. Preferably, the one or more sliding units are configured to be moved to and fro, translationally and/or rotationally, relative to the support device, dependently or independently of one another, between the first slide position and the second slide position.

Preferably, with a sliding unit, the first support channel profile may be varied differently than with a further sliding unit. For example, it may be preferred that the one sliding unit is moved such that the first support channel profile has in portions a first cross-section which is smaller than a cross-section resulting from moving the other sliding unit.

In particular, the slide device is configured to vary, at least in portions, the first support channel profile between the suction surface and the extraction surface. Preferably, the slide device is configured to vary, at least in portions, individual or multiple channels of the first support channel profile between the suction surface and the extraction surface. In particular, the slide device is preferably configured to vary, at least in portions, cross-sections of individual or multiple channels of the first support channel profile between the suction surface and the extraction surface.

In particular, the one or more sliding units are configured to be moved continuously to and fro between the first slide position and the second slide position. This has the advantage that the one or more sliding units can be moved particularly precisely. It may also be preferred that the one or more sliding units are configured to be moved to and fro between the first slide position and the second slide position in discrete steps. This has the advantage that the one or more sliding units can be moved particularly easily.

According to a further preferred embodiment of the workpiece fixing device, in comparison with the second support channel profile, the first support channel profile has a higher number of suction channels per surface area unit. In particular, the cross-section of the channels of the first support channel profile is smaller than the cross-section of the channels of the second support channel profile.

According to a further preferred refinement, it is provided that in comparison with the second fixing region, the first fixing region has a smaller superficial extent. In this way, in particular, smaller workpieces can be fixed particularly efficiently.

According to a further preferred refinement, the first fixing region and the second fixing region extend over the same length in a main machining direction of the workpiece to be machined. In addition or alternatively, the first fixing region extends over a smaller width than the second fixing region orthogonally to the main machining direction.

Furthermore, in a preferred embodiment, a sensor device is provided which is configured to detect a workpiece arranged on the support device, wherein the sensor device is preferably configured to detect a position and/or a position change and/or a position region and/or a size and/or a length and/or a width and/or a height of the workpiece on the support device, in particular on a suction surface of the support device, on which the workpiece arranged on the support device lies.

To detect the position change, the sensor device may for example be configured to detect the location or position of the workpiece on the support device at different times. If the situations or positions of the workpiece detected at the different times differ from one another, a position change has occurred. A preferred threshold value of a position change of the workpiece is for example at least 0.01 mm, at least 0.05 mm, at least 1 mm, at least 5 mm, at least 10 mm or more. If the support device comprises a transport unit on which the workpiece is transported with a transport speed in a main machining direction, the position change of the workpiece is determined taking into account the transport speed and transport direction of the workpiece.

If a position change is detected by the sensor device, the suction power of the suction device may be increased so that a further position change of the workpiece arranged on the support device is prevented.

It may be preferred that the sensor device comprises several sensor units which detect the workpiece arranged on the support device. In particular, it is preferred that several sensor units are arranged spaced apart from one another. Preferably, the sensor units are arranged spaced apart from one another in the main machining direction and/or orthogonally to the main machining direction.

The sensor device, in particular the sensor units, is/are for example configured as line cameras. In particular, as a sensor device, particularly preferably as sensor units, sensors and/or cameras are considered which are configured to detect a position change of the workpiece of at least 0.01 mm, at least 0.05 mm, at least 1 mm, at least 5 mm, at least 10 mm or more.

The sensor device allows the slide device and/or the vacuum chamber to be actuated depending on the size and/or number of workpieces to be fixed. This allows an efficient fixing of workpieces, in particular smaller workpieces, in a particularly simple fashion.

Furthermore, in a preferred refinement of the workpiece fixing device, the at least one vacuum chamber has a chamber volume which is designed to be variable in size, wherein the chamber volume is variable between a first chamber volume and a second chamber volume different from the first. Preferably, the chamber volume of the at least one vacuum chamber is variable depending on the position region detected by the sensor device and/or depending on the size and/or length and/or width and/or height of the workpiece detected by the sensor device.

Furthermore, in a preferred refinement of the workpiece fixing device, it is provided that the at least one vacuum chamber has a partition wall device which is configured to change the chamber volume of the at least one vacuum chamber between the first chamber volume and the second chamber volume.

According to a further preferred refinement, the workpiece fixing device has an actuating device, which is configured to adjust the partition wall device between a first setting position and a second setting position different from the first. Preferably, the at least one vacuum chamber has the first chamber volume in the first setting position of the partition wall device, and has the second chamber volume in the second setting position of the partition wall device.

In a further preferred refinement, the actuating device is configured as a manually operated actuating device and/or is configured as an automatically operated actuating device.

Furthermore, in a preferred refinement, the workpiece fixing device has a suction device for generating a vacuum in the vacuum chamber. The sensor device is preferably arranged upstream and/or downstream of the suction device in the transport direction of the workpiece.

Furthermore, in a preferred refinement of the workpiece fixing device, a control device is provided which is connected for signaling purposes to the sensor device and/or the actuating device and/or the partition wall device and/or the suction device.

Moreover, in a preferred embodiment of the workpiece fixing device, it is provided that the support device comprises a stationary table unit and/or a transport unit which is configured to transport the workpiece to be machined in the main machining direction. Preferably, the stationary table unit has a longitudinal pattern profile. Alternatively or additionally, preferably the transport unit has a hole pattern profile. Furthermore, in addition or alternatively, it is preferably provided that the transport unit is arranged so as to be movable relative to the table unit.

In a further refinement of the workpiece fixing device, it is provided that the transport unit is a conveyor belt or a transport mat, wherein the conveyor belt or the transport mat is preferably endless.

The grinding machine is preferably a wide belt grinding machine. The grinding machine comprises a workpiece fixing device. The workpiece fixing device preferably comprises individual features or a combination of features of the above-described workpiece fixing device.

According to a preferred embodiment of the grinding machine, this has at least one grinding appliance for machining a workpiece fixed by means of a workpiece fixing device.

The method for fixing a workpiece with a workpiece fixing device comprises the following steps:

detection of a workpiece arranged on a support device; and
allocation of the detected workpiece to a first or a second fixing region different from the first.

According to a preferred refinement of the method, the following steps are provided:
adjustment of a size of a chamber volume of at least one vacuum chamber depending on the detected workpiece; and
adjustment of a suction hole profile in the support device in the allocated fixing region depending on the detected workpiece.

According to a further preferred refinement of the method, furthermore the method includes the following step:
adjustment of a suction power of a suction device depending on a detected position change of the workpiece, wherein
preferably, the adjustment of the suction power of the suction device comprises increasing the suction power when the position change of the workpiece lies above a threshold value.

It should be understood that the workpiece fixing device according to the one aspect of the invention, the grinding machine and the method for fixing a workpiece with a workpiece fixing device according to the further aspects of the invention, have the same and similar sub-aspects as those presented in particular in the dependent claims. To this extent, reference is made to the above description in full.

Embodiments of the invention are now described below with reference to the drawings. These are intended to illustrate the embodiments, not necessarily to scale; rather, the drawings—where serving for explanation—are schematic and/or shown in slightly distorted form. With reference to additions from the teaching directly identifiable from the drawings, reference is made to the relevant prior art. It must be taken into account that many modifications and changes may be made concerning the form and detail of an embodiment without deviating from the general concept of the invention. The features of the invention disclosed in the description, drawings and claims may be essential for the refinement of the invention, both individually and in arbitrary combination. Also, the scope of the invention covers all combinations of at least two of the features disclosed in the description, drawings and/or claims. The general concept of the invention is not restricted to the precise form or detail of the preferred embodiments shown and described below, or limited to a subject which would be restricted in comparison with the subject claimed in the claims. For the sake of simplicity, the same reference signs are used below for identical or similar parts, or parts with identical or similar function.

### DESCRIPTION OF THE DRAWINGS

Preferred embodiments of the invention are explained as examples below with reference to the appended figures.

FIG. 1 shows an isometric view of a preferred embodiment of a workpiece fixing device;

FIG. 2 shows a top view of a conveyor belt of the workpiece fixing device illustrated in FIG. 1;

FIG. 3 shows a detail view of a table unit of the workpiece fixing device illustrated in FIG. 1;

FIG. 4 shows a sectional view of a further preferred embodiment of a workpiece fixing device, which is based on the embodiment of the workpiece fixing device illustrated in FIG. 1; and

FIG. 5 shows a schematic flow diagram of a preferred embodiment of a method for fixing a workpiece with a workpiece fixing device.

### DETAILED DESCRIPTION

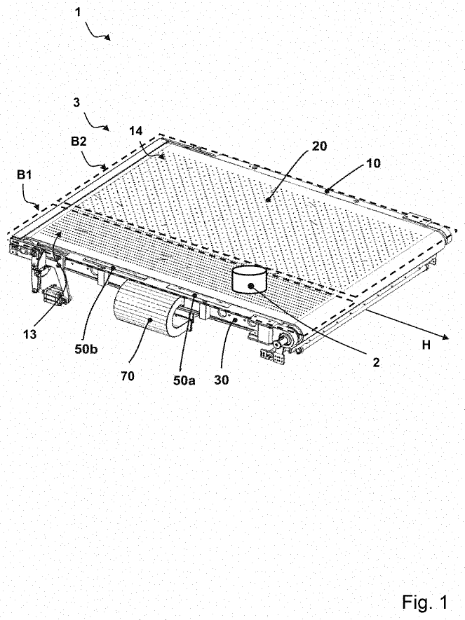

FIG. 1 shows an isometric view of a preferred embodiment of a workpiece fixing device 1, for fixing a workpiece 2 for machining thereof. A grinding machine (not shown), for example a wide belt grinding machine, may fix workpieces 2 by means of such a workpiece fixing device 1 for machining.

The workpiece fixing device 1 has a support device 3. In this preferred embodiment, the support device 3 comprises a stationary table unit 10 and a transport unit 20. The transport unit 20 is arranged so as to be movable relative to the table unit 10 and is configured as an endless conveyor belt or endless transport mat. For machining the workpiece, the transport unit 20 conveys the workpiece 2 to be machined in a main machining direction H along a machining appliance, for example a grinding appliance (not shown). For this, the workpiece to be machined is first arranged on the support device 3, or in the present case, the transport unit 20.

The support device 3 extends between a suction surface 11 and an extraction surface 12. The workpiece 2 to be machined is laid on the suction surface 11 of the support device 3 for machining and fixed there. To fix the workpiece 2 to the support device 3, the workpiece fixing device 1 has a vacuum chamber 30 which extends starting from the extraction surface 12 of the support device 3. Via a vacuum connection 70, a vacuum is generated in the vacuum chamber 30, by means of which air is aspirated from the environment through the suction surface 11. This results in a vacuum which sucks the workpiece 2 onto the suction surface 11. The vacuum connection 70 is fluidically connected to a suction device (not shown) which aspirates the air.

FIG. 1 shows that the workpiece fixing device 1 has a first fixing region B1 and a second fixing region B2 different from the first fixing region B1. In comparison with the second fixing region B2, the first fixing region B1 has a smaller superficial extent. The first and second fixing regions B1, B2 here extend over the same length in the main machining direction H of the workpiece 2 to be machined. However, in comparison with the second fixing region B2, the first fixing region B1 has a smaller width orthogonally to the main extent direction.

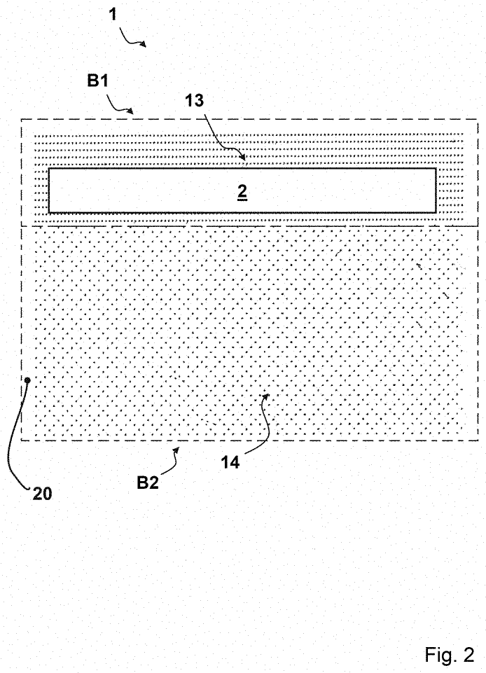

It is provided that the support device 3 has a first support channel profile 13 in the first fixing region B1 and a second support channel profile 14, different from the first support channel profile 13, in the second fixing region B2. In comparison with the second support channel profile 14, the first support channel profile 13 has a substantially more finely pitched arrangement of the channels through which air is aspirated. This is also shown in FIG. 2, which shows a top view of a conveyor belt of the workpiece fixing device 1 illustrated in FIG. 1, on which an elongate workpiece 2 is fixed. Substantially, in comparison with the second support channel profile 14, the first support channel profile 13 has a higher number of suction channels per surface area unit.

The support device 3 of the embodiment shown in FIG. 1 has a slide device 50 in the first fixing region B1. The slide device 50 is arranged between and is movable relative to the transport unit 20 and the table unit 10. In the present exemplary embodiment, the slide device 50 can be moved to and fro, relative to the support device 3, between a first slide position and a second slide position different from the first. In cooperation with the support device 3, in the first slide position, the slide device 50 forms a first suction hole profile and in the second slide position, a second suction hole profile different from the first suction hole profile.

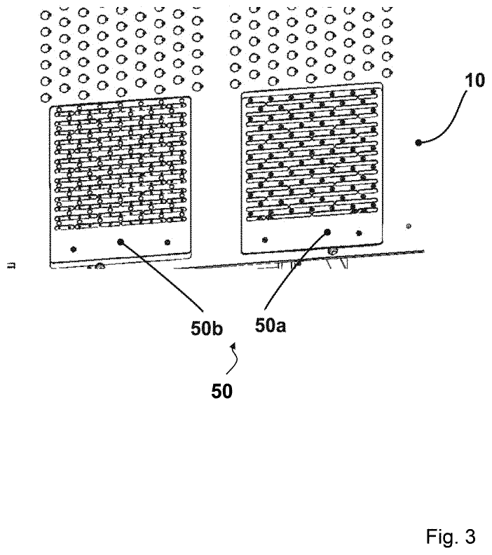

The slide device 50 illustrated in FIG. 1 comprises two sliding units 50a, 50b which are configured to be moved to and fro, relative to the support device 3, independently of one another, between the first slide position and the second slide position. This is shown by the detail view in FIG. 3 onto the table unit 10 of the workpiece fixing device 1 illustrated in FIG. 1. The sliding unit 50a arranged on the right is in a first slide position which is configured for fixing of larger workpieces 2. The sliding unit 50b arranged on the left is in a second slide position which is suitable for fixing smaller workpieces 2.

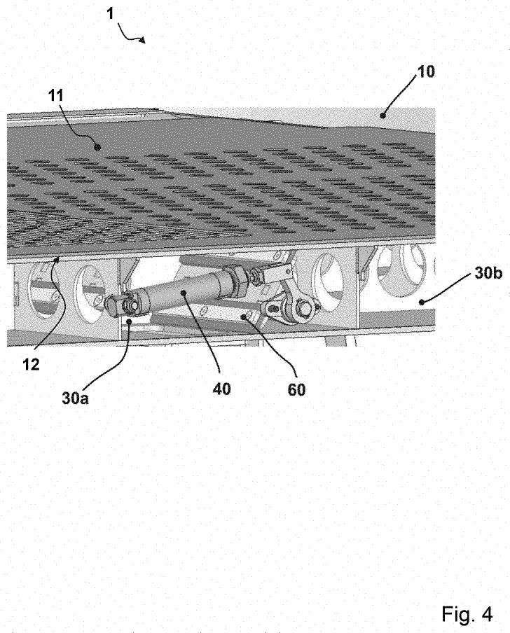

FIG. 4 shows a sectional view of a further preferred embodiment of a workpiece fixing device 1 which is based on the embodiment of the workpiece fixing device 1 illustrated in FIG. 1. The embodiment illustrated in FIG. 4 differs from the embodiment illustrated in FIG. 1 by the use of two vacuum chambers 30a, 30b, wherein one of the two vacuum chambers 30a has a chamber volume which is designed variably in size. The chamber volume of this vacuum chamber 30a can be changed between a first chamber volume and a second chamber volume different from the first. To change the chamber volume, the vacuum chamber 30a has a partition wall device 60 which can be adjusted between a first setting position and a second setting position different from the first. In this way, the chamber volume of the vacuum chamber 30a may be adjusted between a first chamber volume in the first setting position and a second chamber volume in the second setting position.

In order to adjust the partition wall device 60 between the first and second setting positions, the embodiment of the workpiece fixing device 1 illustrated in FIG. 4 comprises an actuating device 40. The actuating device 40 may be configured for manual operation, or—as provided here—for automatic operation.

For automatic operation of the actuating device 40, the workpiece fixing device 1 has a sensor device (not shown) and a control device (not shown).

The sensor device is configured to detect a workpiece 2 arranged on the support device 3. In the present case, the sensor device is configured to detect a position region, a size, a length, a width, and a height of the workpiece 2 on the suction surface 11 of the support device 3 on which the workpiece 2 arranged on the suction device 3 lies. In particular, the sensor device is also configured to detect a position change of the workpiece 2 arranged on the support device 3. For this, it is provided to detect the position of the workpiece at different times, and compare these with one another taking into account the transport speed and transport direction. If the comparison shows that the positions detected at different times are not identical, a position change of the workpiece has occurred. In the present preferred exemplary embodiment, this may for example cause an increase in the suction power of the suction device.

The control device is connected for signaling purposes to the sensor device, the actuating device 40, the partition wall device 60 and the suction device. The control device is configured to adjust the chamber volume of the vacuum chamber 30a depending on the position region detected by the sensor device, or the size, length, width and height of the workpiece 2 detected by the sensor device.

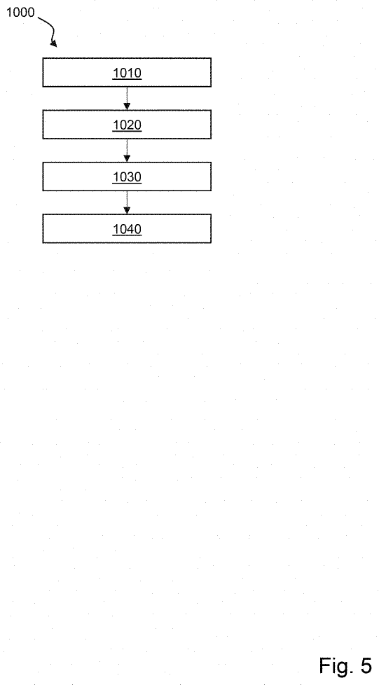

FIG. 5 shows a schematic flow diagram of a preferred embodiment of a method 1000 for fixing a workpiece 2 with a workpiece fixing device 1.

In the embodiment illustrated here, the method 1000 comprises the steps of detection 1010 of a workpiece 2 arranged on the support device 3, and allocation 1020 of the detected workpiece 2 to a first B1 or to a second fixing region B2 different from the first. Furthermore, the method 1000 comprises adjustment 1030 of a size of a chamber volume of at least one vacuum chamber 30, 30a, 30b depending on the detected workpiece 2, and adjustment 1040 of a suction hole profile in the support device 3 in the allocated fixing region B1, B2 depending on the detected workpiece 2.

### LIST OF REFERENCE SIGNS

1 Workpiece fixing device
2 Workpiece
3 Support device
10 Table unit
11 Suction surface
12 Extraction surface
13 First support channel profile
14 Second support channel profile
20 Transport unit, conveyor belt, transport mat
30, 30a,b Vacuum chamber
40 Actuating device
50 Slide device
50a,b Sliding units
60 Partition wall device
70 Vacuum connection
B1, B2 First, second fixing region
H Main machining direction

1. A workpiece fixing device for fixing a workpiece by vacuum for machining thereof, comprising:
a support device on which the workpiece can be laid for fixing, and at least one vacuum chamber which is formed starting from the support device,
wherein the support device comprises a first fixing region and a second fixing region different from the first fixing region,
wherein the support device has a first support channel profile in the first fixing region and a second support channel profile different from the first support channel profile in the second fixing region.

2. The workpiece fixing device according to claim 1, further comprising a slide device arranged in the first fixing region, wherein the slide device and the support device are arranged so as to be movable relative to one another.

3. The workpiece fixing device according to claim 2 wherein the slide device and the support device are arranged so as to be movable translationally and/or rotationally relative to one another.

4. The workpiece fixing device according to claim 1,
wherein the slide device and/or the support device are configured so they can be moved to and fro, relative to one another, between a first slide position and a second slide position different from the first, wherein the slide device and/or the support device are movable to and fro translationally and/or rotationally, relative to one another between the first slide position and the second slide position, and
wherein the slide device and the support device, in the first slide position of the slide device, form a first suction hole profile, and in the second slide position of the slide device, form a second suction hole profile different from the first suction hole profile.

5. The workpiece fixing device according to claim 4 wherein the first suction hole profile is the first support channel profile.

6. The workpiece fixing device according to claim 2 wherein the slide device has one or more sliding units which are configured to be moved to and fro, relative to the support device, dependently or independently of one another, between the first slide position and the second slide position, wherein the one or more sliding units are configured to be moved to and fro, translationally and/or rotationally, relative to the support device, dependently or independently of one another, between the first slide position and the second slide position.

7. The workpiece fixing device according to claim 1,
wherein in comparison with the second support channel profile, the first support channel profile has a higher number of suction channels per surface area unit, and/or
wherein in comparison with the second fixing region, the first fixing region has a smaller superficial extent.

8. The workpiece fixing device according to the preceding claim 7,
wherein the first fixing region and the second fixing region extend over a same length in a main machining direction of the workpiece to be machined; and/or
wherein the first fixing region extends over a smaller width than the second fixing region orthogonally to the main machining direction of the workpiece to be machined.

9. The workpiece fixing device according to claim 1 further comprising a sensor device to detect a workpiece arranged on the support device.

10. The workpiece fixing device according to claim 9 wherein the sensor device is configured to detect a position and/or a position change and/or a position region and/or a size and/or a length and/or a width and/or a height of the workpiece on the support device.

11. The workpiece fixing device according to claim 10 wherein the sensor device detects the position and/or the position change and/or the position region and/or the size and/or the length and/or the width and or the height of the workpiece on a suction surface of the support device.

12. The workpiece fixing device according to claim 9 wherein the at least one vacuum chamber has a chamber volume which is designed to be variable in size, wherein the chamber volume is variable between a first chamber volume and a second chamber volume different from the first, and wherein the chamber volume of the at least one vacuum chamber is variable depending on the position region detected by the sensor device and/or depending on the size and/or length and/or width and/or height of the workpiece detected by the sensor device,

13. The workpiece fixing device according to claim 1
wherein the at least one vacuum chamber has a chamber volume which is designed to be variable in size, wherein the chamber volume is variable between a first chamber volume and a second chamber volume different from the first, and/or
wherein the at least one vacuum chamber has a partition wall device which is configured to change the chamber volume of the at least one vacuum chamber between the first chamber volume and the second chamber volume.

14. The workpiece fixing device according to claim 13 further comprising an actuating device configured to adjust the partition wall device between a first setting position and a second setting position different from the first, wherein the at least one vacuum chamber has the first chamber volume in the first setting position of the partition wall device and has the second chamber volume in the second setting position of the partition wall device.

15. The workpiece fixing device according to claim 14, wherein the actuating device is configured as a manually operated actuating device, and/or is configured as an automatically operated actuating device.

16. The workpiece fixing device according to claim 1 further comprising a suction device for generating a vacuum in the vacuum chamber with a suction power, and/or a control device connected for signaling purposes to a sensor device and/or an actuating device and/or a partition wall device and/or the suction device.

17. The workpiece fixing device according to claim 1 wherein the support device comprises
a stationary table unit; and/or
a transport unit configured to transport the workpiece to be machined in a main machining direction;
wherein
the stationary table unit has a longitudinal pattern profile; and/or
the transport unit is arranged so as to be movable relative to the stationary table unit; and/or
the transport unit has a hole pattern profile; and/or
the transport unit is a conveyor belt or a transport mat.

18. A grinding machine comprising a workpiece fixing device according to claim 1 for fixing one or more grinding appliances for machining a workpiece.

19. A method for fixing a workpiece by vacuum for machining thereof, comprising:
providing a workpiece fixing device according to claim 1;
detecting a workpiece arranged on a support device of the workpiece fixing device; and
allocating the detected workpiece to a first fixing region or a second fixing region different from the first fixing region.

20. The method according claim 19, further comprising:
adjusting a size of a chamber volume of at least one vacuum chamber of the workpiece fixing device depending on the detected workpiece; and/or
adjusting a suction hole profile in the support device in the allocated fixing region depending on the detected workpiece; and/or
adjusting a suction power of a suction device depending on a detected position change of the workpiece, wherein adjustment of the suction power of the suction device comprises increasing the suction power when the position change of the workpiece lies above a threshold value.
